(19) United States
(12) Patent Application Publication
(10) Pub. No.: US 2005/0167974 A1
(43) Pub. Date: Aug. 4, 2005

(54) Entertainment card and method of use

(76) Inventors: William Green, Huntington Beach, CA (US); David R.R. Green, Wilmington, DE (US)

Correspondence Address: Connolly Bove Lodge & Hutz LLP, P.O. Box 2207, Wilmington, DE, 19899-2207, US

(21) Appl. No.: 10/771,965

(22) Filed: Feb. 4, 2004

(51) Int. Cl. G09C 3/00; B42D 15/00

(52) U.S. Cl. 283/75

(57) ABSTRACT

An entertainment card includes a depiction of a person on one side of the card. A transparent window is formed in the card at a location which includes a portion of the anatomy of the depicted person which has a crease-like area such as the buttocks or breasts. The absent portion of the anatomy is replaced by a user's digit being pressed against the window to simulate the absent portion in an appearance of bare skin.

### BACKGROUND OF THE INVENTION

Various types of cards are used for different purposes. For example, some cards such as business cards or business name cards are used to identify a business and/or person. Larger size cards of credit card size are also used for various purposes such as in advertising different businesses. Similarly, index cards are used to provide various information. Other forms of cards in use include playing cards for playing various games such as poker, solitaire, etc. Other forms of cards are trading cards which might be used for various sports showing pictures of different athletes and containing information pertinent to those athletes. Still other forms of cards are greeting cards; such as get well cards and birthday cards.

It would be desirable if any or all of the above type cards could be modified to also have some entertainment value.

### SUMMARY OF THE INVENTION

An object of this invention is to provide an entertainment card that would give instantaneous enjoyment.

A further object of this invention is to provide such an entertainment card which gives the enjoyment by a user completing an absent portion of the card.

In accordance with this invention a card includes on one side a depiction of a person. A transparent window is formed in the card at a location which includes a portion of the anatomy of the depicted portion so that the window creates an absence of that portion of the anatomy. The absent portion of the anatomy is one which would have a crease-like area. The absent portion of the anatomy is then replaced by a user's digit(s), such as a bent finger, being placed against the window to simulate the absent portion in an appearance of bare skin.

In a preferred practice of this invention the window is formed by a cut-out completely through the card. As a result, when the bent finger is placed against the window or cut-out a portion of the bent finger can extend through the cut-out to give a 3-D affect.

The absent portion of the anatomy of the depicted person could be the buttock which would then be simulated by the bent finger or could be a portion of a women's breasts wherein the bent finger would simulate cleavage. The card could also contain written material providing information pertinent to the depicted person.

### THE DRAWINGS

FIG. 1 is a front elevational view of an entertainment card in accordance with this invention showing a user's bent finger near the card;

FIG. 2 is a view similar to FIG. 1 showing the bent finger pressed against the card;

FIG. 3 is a view similar to FIG. 2 showing use of the card with a different depicted person; and

FIG. 4 is a rear elevational view of the card of FIG. 1 showing the card to include printed material.

### DETAILED DESCRIPTION

The present invention relates to an entertainment card for providing instantaneous enjoyment to a user or others viewing the card when it is used. In general, the invention involves having a depiction of a person on one side of the card. A transparent window is formed in a portion of the depicted person thereby creating an absence of that portion from the depicted person. The absent portion would correspond to a portion of the anatomy having a crease-like area such as the buttocks or breasts. The user then places the user's digit(s), preferably a bent finger against the window from the opposite side to simulate the absent portion in an appearance of bare skin.

Where the window is a hole through the card, the finger extends partially through the hole to give a three dimensional (3D) affect.

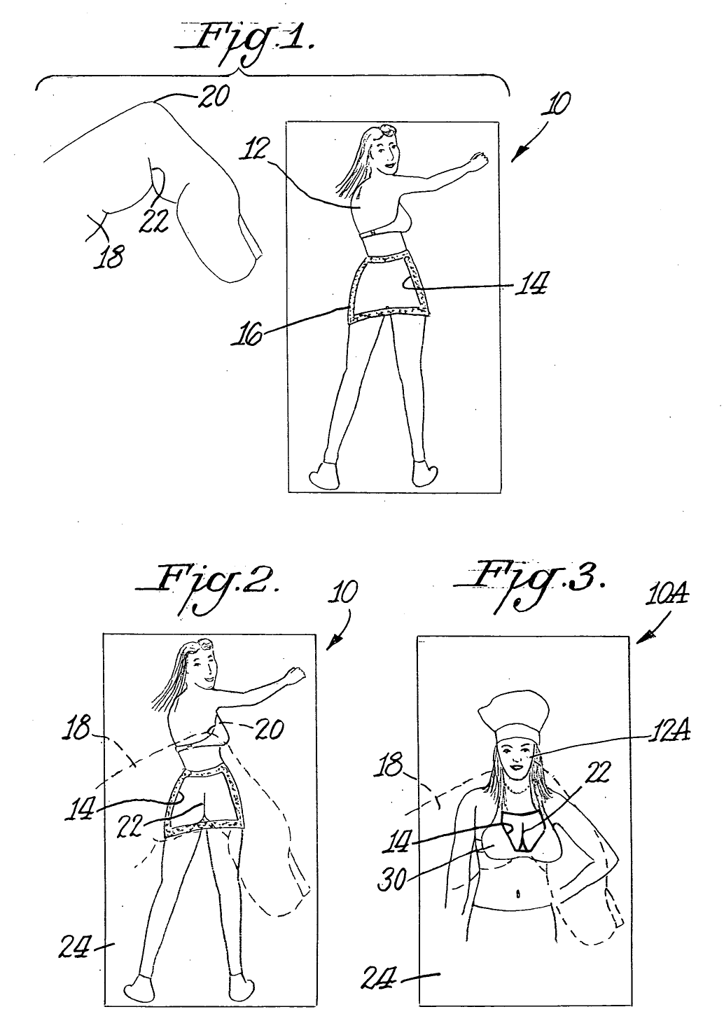

FIG. 1 shows one form of business card 10 in accordance with this invention. As shown therein, the card has a first side which includes a depicted person 12. A window 14 is formed through the card in a portion of the anatomy of the depicted person. In the card 10 illustrated in FIG. 1 this absent portion of the anatomy would correspond to the buttocks. Preferably, at least some and in the version of FIG. 1 all of the window is surrounded by a depiction of clothing 16 such as a skirt.

FIG. 1 also shows a user's index finger 18. The index finger is shown as being bent with the knuckle 20 being upward and with the bent portion being in the form of a crease 22.

FIG. 2 shows the use of the card 10. As shown therein the bent portion of the index finger 18 is placed against the opposite or second side of the card 10 at the window 14 with the knuckle 20 being upward. The crease 22 and the surrounding portions of the finger 18 thereby simulate the absent portion of the depicted person, namely, the buttocks.

In the preferred practice of this invention the window 14 is a cut-out completely through the card. The depicted person is shown on the first side 24 of the card with the finger 18 pressed against the second side 26 (see FIG. 4 for the opposite side of the card). Because the window 14 is a cut-out at least a portion of the bent finger can extend through and slightly beyond the first side 24 thereby creating a three-dimensional or 3D affect wherein the remainder of the card has a 2D affect.

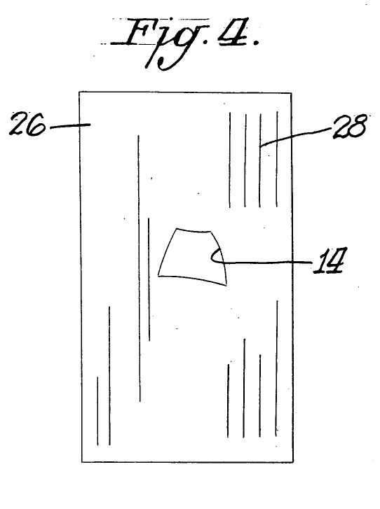

FIG. 3 shows a variation of the invention wherein the card 10A has the depiction of a different person 12A with the window 14 or absent portion of the anatomy being at least a portion of the breasts. Thus, when the person's finger 18 is pressed against the second side 26 with the crease 22 located at the window 14 the bent finger simulates breast cleavage.

The card may also be used to provide printed material, preferably information relating to the depicted person. FIG. 4 illustrates the backside 26 to include such printed information 28.

In the preferred practice of this invention window 14 is a cut-out. If desired, however, the window can be completely covered by a protective transparent shield. Where the shield is made of a stiff material the shield helps protect the card by adding to its stiffness or shape retaining characteristics. The transparent shield, however, could be made of a flexible material so that when the bent finger is placed against the window the bent finger could press against the flexible material and still extend partially through the window.

In the preferred practice of the invention the card is made from a generally stiff shape retaining material. Preferably, the substrate is a laminate having at least one overlay transparent layer. The depicted person could be a photograph or a reproduction of a photograph or could be a drawing or even a caricature.

The card could be of any size and shape. The preferred practices of the invention include business cards or business name cards which could be as small as, for example, two inches by three and one-half inches. The card could also be of credit card size or playing card size which might be about two and one-eight by three and three-eight inches. Similarly, the card could be of index card size with standard index cards being three by five inches or larger index cards, five by eight inches. Within these sizes of cards are also trading cards, such as used to depict athletes. Where the invention is used with greeting cards, virtually any size and shape could be used.

FIGS. 1-3 show the card where the depicted person is oriented vertically with respect to the long dimension of the card. The invention, however, could be practiced where the person is vertically with respect to the small dimension of the card.

Any materials may be used for the substrate which forms the card. Such materials could be plastic, high-gloss paper, photocopy paper, laminated paper, etc.

Although FIGS. 1-3 illustrate the depicted person to be a female, the depicted person could also be a male, particularly where the cut-out area is the buttocks. Other portions of the anatomy such as where the arm and shoulder meet when the arm is hanging straight downwardly against the side could also be used for the absent area of the anatomy which is then simulated by the bent finger. Because the index finger is relatively narrow and easy to manipulate the index finger is the preferred finger of use. The invention may be practiced, however, with other fingers or digits, as later described.

Although FIGS. 1-3 depict the person as a female without any particular surroundings the depicted person and the card could include different scenery such as, for example, beach scenery for a woman in a bikini or could depict a woman in a skirt, a dress or shorts in any type of scene including a woman having ski pants on a ski slope or otherwise being dressed for the beach. Where a male is used as the depicted person the male could be on a ball field or could be shown doing a workout program.

In addition to providing general entertainment by use of the card, the card would be ideally suited for various entertainment clubs catering to men or catering to women. For example, in an adult club featuring women, the card could depict the different women employed at that club with the information 28 being pertinent to the particular woman such as name, age, dimensions, hobbies, etc. Similarly, where an adult club features men, the printed information 28 could correspond to the male being depicted on the front side. In addition, or instead of having the printed information on the second or back side of the card, printed information could also be on the front or first side.

Where the invention is used for greeting cards the substrate having the transparent window would preferably be the back page of a folded greeting card. Accordingly, the front page could contain some form of message and then when the card is opened to expose the back page the person's anatomy and the transparent window would be visible. If the greeting card is a get well card the back page could show, for example, a recuperating patient with the appropriately located window. This would allow, for example, the index finger of the person holding the card to show through the transparent window. Other forms of greeting cards could also be used, such as birthday cards, anniversary cards and other special occasion or “no occasion” cards.

In a preferred practice of the invention the absent portion of the anatomy of the depicted person is at least partially surrounded by clothing on the depicted person. Thus, for example, the skirt 16 in FIGS. 1 and 2 completely surround the window 14 while the top 30 in FIG. 3 at least partially surrounds the absent portion. Having the clothing surrounding the absent portion is preferred to avoid any connotation of the card being intended for lewd purposes. Although, less preferred, however, the invention could be practiced where the window 14 is not surrounded by clothing.

Although the preferred practice of the invention is to use the bent index finger to simulate the absent portion of the depicted person, other digits, i.e., fingers or toes, may also be used. Thus, for example, two fingers pressed together, such as the two index fingers from both hands, could be placed at the window. The bent finger could be a finger other than the index finger, although it is more difficult to press such other fingers against the window unless the window is located close to the top or bottom edge of the card. Similarly, instead of fingers toes could be used. The preferred digit, however, is the index finger.

1. An entertainment card comprising a substrate, said substrate having a first side and an opposite second side, a depiction of a person on said first side, a transparent window formed in said substrate at a location which includes a portion of the anatomy of the depicted person, said window creating an absence of said portion from the depicted person, said portion of the anatomy including a crease-like area which can be replaced by a user's digit(s) being placed against said window at said second side to simulate the absent portion in an appearance of bare skin, and said absence of said portion of said anatomy being thereby completed at said window independently of any other portion of said card.

2. The card of claim 1 wherein said window is a cutout completely through said substrate whereby the user's digit(s) can extend partially through said cutout at least slightly beyond said first side to create a 3-D affect with the remainder of said substrate having a 2-D affect.

3. The card of claim 1 wherein said portion of said anatomy is the buttocks.

4. The card of claim 1 wherein said portion of the anatomy is the breasts whereby the user's digit(s) simulates cleavage.

5. The card of claim 1 wherein said substrate is made of stiff shape-retaining material.

6. The card of claim 5 wherein said substrate is made of a laminated material.

7. The card of claim 5 wherein said substrate is of a size between a business card to an index card.

8. The card of claim 5 wherein said substrate has a width in the range of about 2 to about 5 inches and a length in the range of about 3½ inches to about 8 inches.

9. The card of claim 5 wherein said card is a business card.

10. The card of claim 5 wherein card is of credit card size.

11. The card of claim 5 wherein said card is of index card size.

12. The card of claim 1 including printed material on one of said sides relating to information about the depicted person.

13. The card of claim 12 wherein said printed material is on said second side.

14. The card of claim 1 wherein said window is at least partially surrounded by clothing on the depicted person.

15. The card of claim 1 wherein the depicted person is a female.

16. The card of claim 1 wherein the depicted person is a male.

17. The card of claim 1 including a transparent shield across said window.

18. The card of claim 1 wherein the card is a greeting card.

19. The card of claim 18 wherein said greeting card has a front page and a back page, and said window is in said back page.

20. A method of providing amusement with an enter-tainment card comprising the steps of providing the card of claim 1, and placing at least one of the user's digit(s) having a crease against the second side at the window so that the crease in the digit(s) simulates the anatomical crease-like area of the absent portion of the depicted person and the digit (s) gives the appearance of bare skin.

21. The method of claim 20 wherein at least one digit is a bent finger.

22. The method of claim 21 wherein the bent finger is the index finger, at the knuckle and the knuckle is oriented upwardly.

23. The method of claim 22 wherein the window is a cutout, and pressing the bent finger against the cutout so that some of the bent finger extends outwardly of the cutout on the first side to create a 3-D affect.

24. The method of claim 23 wherein the absent portion is the buttocks, and the bent finger thereby simulates the buttocks.

25. The method of claim 23 wherein the absent portion includes at least a portion of a woman's breasts, and the bent finger simulates breast cleavage.

26. The method of claim 20 wherein clothing on the depicted person surrounds at least part of the window.

27. The method of claim 20 wherein the card is selected of a size ranging from a business card to an index card.

28. The method of claim 20 wherein the card is a greeting card.

29. The method of claim 28 wherein the greeting card has a front page containing a message and a back page having the window.
